(19) United States
(12) Patent Application Publication
(10) Pub. No.: US 2006/0291936 A1
(43) Pub. Date: Dec. 28, 2006

(54) Resource expander key

(76) Inventor: Suni Vili Perez, Ocala, FL (US)

Correspondence Address: SUNI V. PEREZ, 2437 NE 6TH STREET, APT. 3, OCALA, FL, 34470-6254, US

(21) Appl. No.: 11/262,165

(22) Filed: Oct. 24, 2005

Related U.S. Application Data
(60) Provisional application No. 60/697,444, filed on Jun. 28, 2005.

(51) Int. Cl. G06F 3/023

(52) U.S. Cl. 400/472

(57) ABSTRACT

Typists press single keys separately to get single pieces of text. For example, the “a” key produces “a” text. Machine stenotypes press more than one key together to get single pieces of text. For example, the “g” produced In stenotype by pressing down the “t”, “k”, “p” and “w” keys all at the same time. Suni's new RESOURCE EXPANDER KEY will enable each finger of the human hand, which can now produce 4 characters on a conventional type-writer keyboard (EXAMPLE: left pinkie: “1, q, a z”) to now produce 9 times that number! It does this within a space similar to that of the conventional typewriter keyboard through the use of silver or spot keys, which can be hit with a center key, but which unlike most keys today take up little room, because they are never meant to be hit alone.

### BACKGROUND OF THE INVENTION

Suni graduated from Brooklyn College in 1966 and attended the STENO-TYPE ACADEMY from 1965-1967. She found there was no standardized stenotype notation and that every stenotypist developed his own way of typing words using abbreviations. In her desire to create order from chaos, Suni devoted herself to the task of standardizing stenotype. (She established two ways of recording words:
1) a one-stroke way, in which each word had one unique notation onto which verb and noun endings could be added in the same stroke
2) a multi-stroke way based on spelling, in which certain spelling combinations could be rendered in only one way.

This effort let to many Copyrights over the years, namely:

TXU 15-582 (Nov. 4, 1978) “THE SUNI COMPUTER STENOTYPE SYSTEM DICTIONARIES”

TXU 15-139-755 (Oct. 2, 1983) “THE ABRIDGED SUNI STENOTYPE SYSTEM”

TXU 157-107 (Apr. 9, 1984) “SUNI WORD PROCESSOR STENO”

TXU 175-536 (Jul. 13, 1964) “SUNISTENO 1: The Student, Secretary, Writer, Suni Word Processor Steno, Self-Study Manual”

TXU 237-268 (Apr. 22, 1986) “SUNITYPE FOR EVERYONE: A Self-Study Manual”

TXU 249-121 (Aug. 8 1986) “SUNITYPE FOR EVERYONE: Edition 2: A Self-Study Manual”

This concentrated work convinced Suni that the current stenotype keyboard, even with some modifications, has too few resources to handle the English language well. One-stroke notations, not based on English spelling, created too much to learn. Multistroke notations based on English spelling took too many strokes on the stenotype keyboard to type. Suni realized she needed a keyboard capable of handling many more combinations, such as found in multisyllabic words, not just in single syllables.

### SUMMARY OF INVENTION

In 2004, it occurred to Suni that she could mix typing and stenotype to make a high-capacity keyboard, which would enable a typist to spell correctly words up to 5 syllables in a single stroke on the keyboard. Her invention, called a RESOURCE EXPANDER KEY, consists of a central key surrounded by silver keys or point keys in the form of a square. The finger tip, by sensing corners and sides, will be able to produce 9 pieces of text in the same area on the computer keyboard where it only produces 1 today.

The following is an example of 9 pieces of text a single RESOURCE EXPANDER KEY can produce, by pressing the center key alone or together with surrounding silver or spot keys. The surrounding subsidiary keys are envisioned by the typist like the corners and sides of a surrounding square. What part of that surrounding square the typist feels with the tips of his fingers, will determine what text is produced. Below is an example for just on RESOURCE EXPANDER KEY.

“b”—top left corner+center key

“h”=right side+center key

“c”=top side+center key

“d”=top right corner+center key

“f”=left side+center key

“g”=center key alone

“j”=bottom left corner+center key

“k”=bottom side+center key

“l”=bottom right corner+center key

This promises to revolutionize word processing. Suni has already copy-righted her teaching manual: “COMPUTER SPEED TYPE COURSE MANUAL” TXU 1-238-358 (Apr. 8, 2005)

### DESCRIPTION OF DRAWINGS

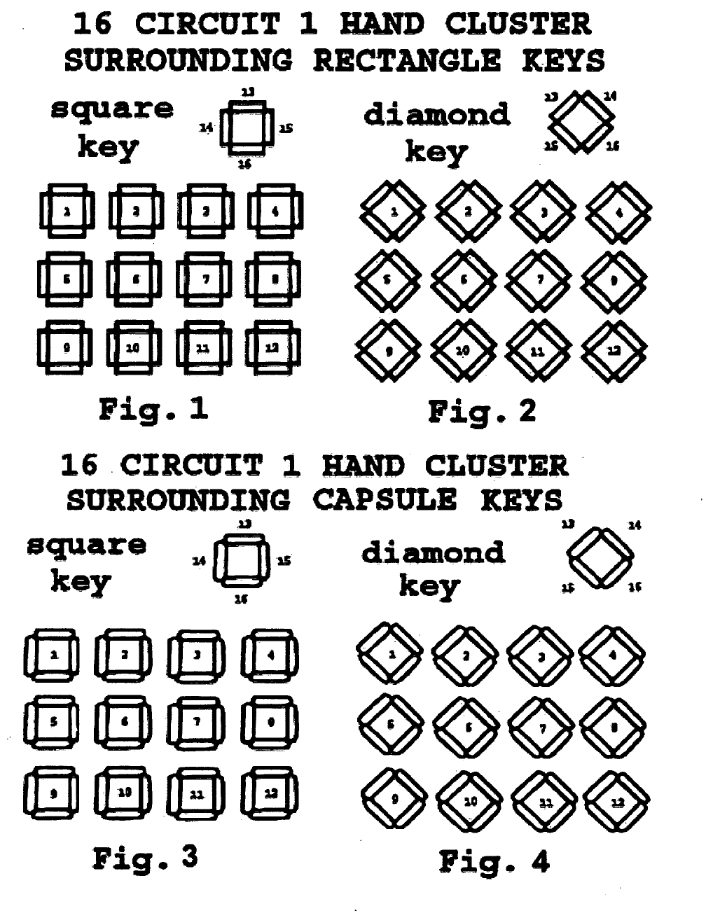

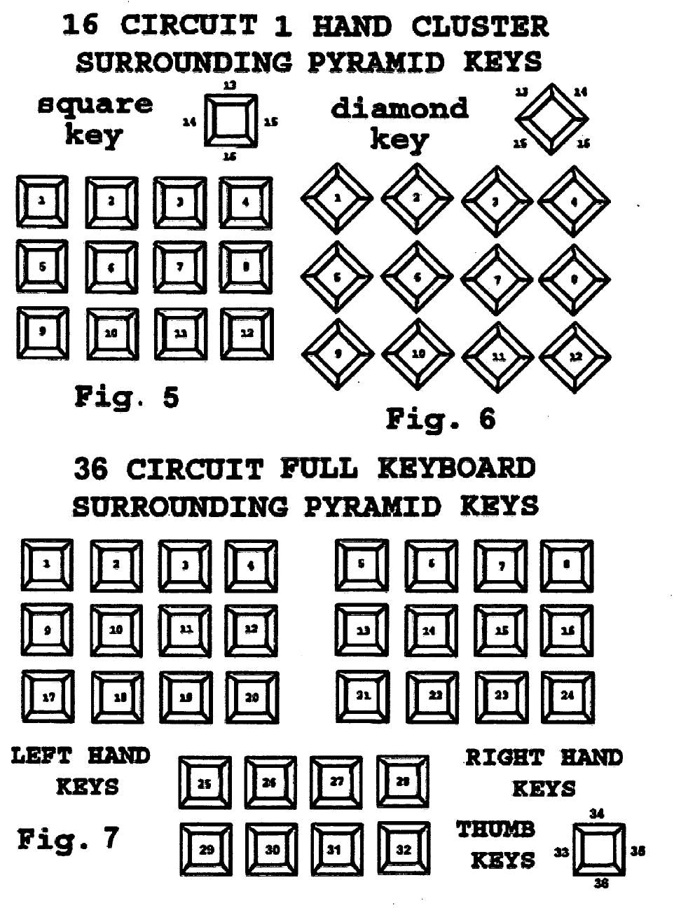

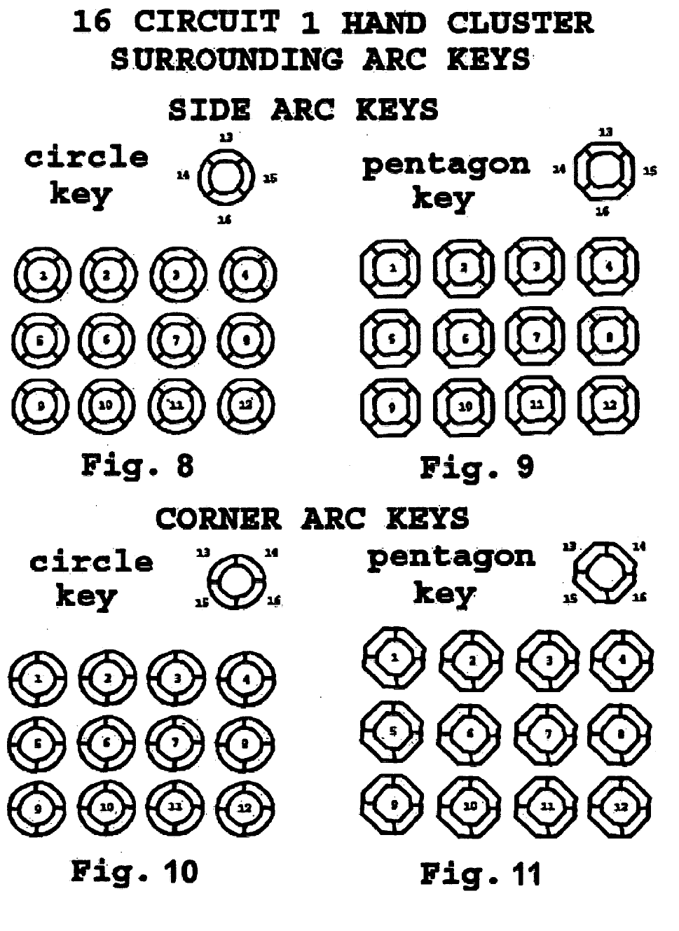

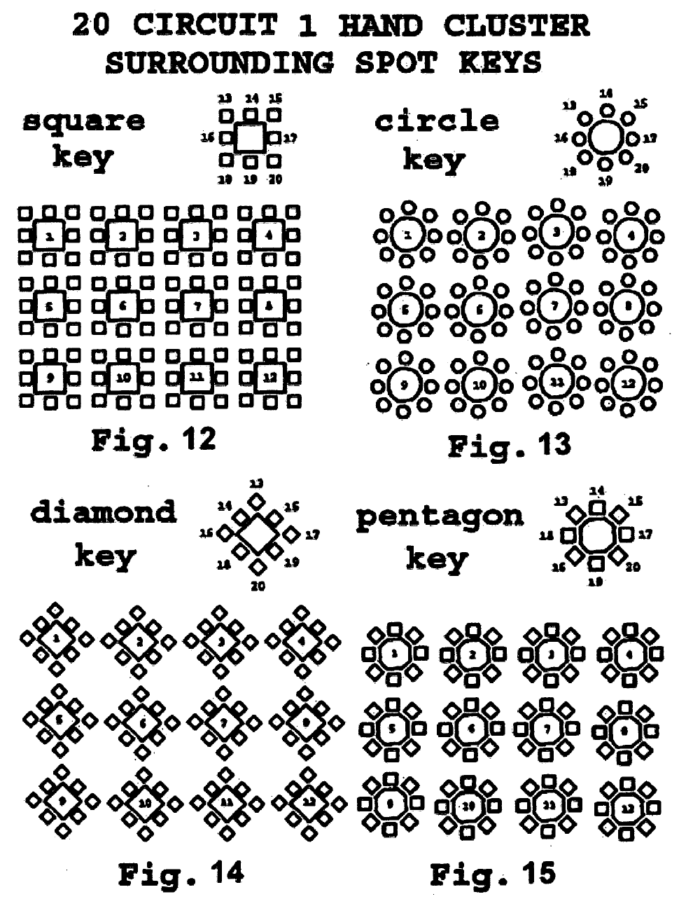

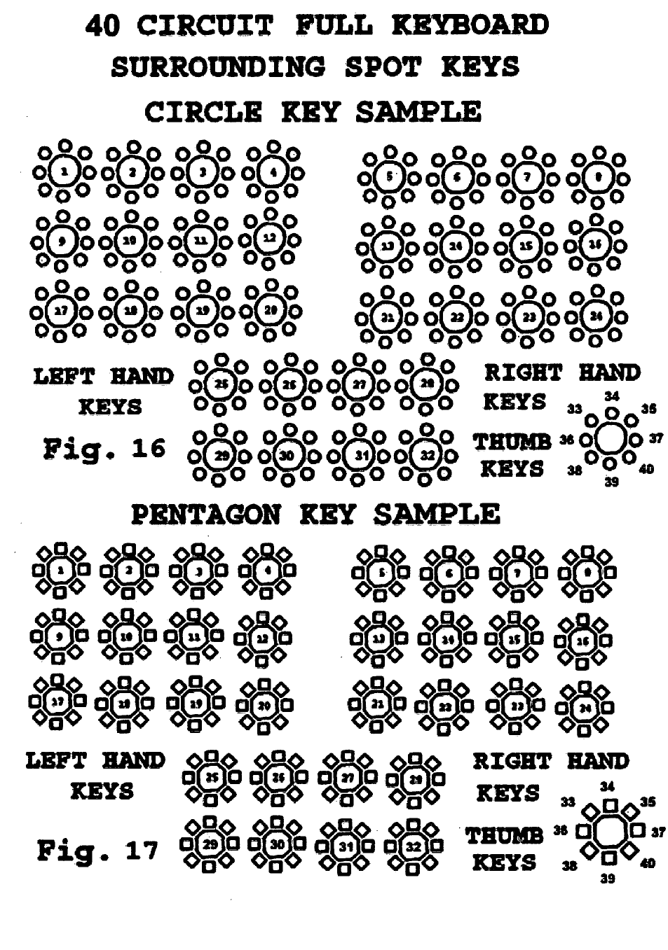

On the first sheet is a series of possible designs for RESOURCE EXPANDER KEYS. FIGS. 1-6 and FIGS 8-15 show RESOURCE EXPANDER KEYS in one-hand clusters. These are operated by every finger except the thumbs. To see what a whole keyboard might look like ‘refer to FIG. 7 and FIGS. 16-17. The thumb keys borrow from machine stenotype in that they do more than just press a space bar. They provide vowels. In machine stenotype, these vowels fit comfortably in single syllables. On Suni's new keyboard, they will provide vowels for 2 syllables in multisyllabic words, namely the second and the fourth syllables.

Tiny numbers from 1 to 40 indicate the number of circuits required. Center keys account for circuits from 1 to 32. Surrounding silver keys will add 4 circuits, making the total number 36. Surrounding point keys will add 8 circuits, making the total number 40. (Note: The number of circuits will vary with the design and options decided on in the final working model. The goal is always versatility with the fewest number of keys possible.)

What Suni claims as her invention is:

1) a new, original type of key, which through surrounding silver or spot keys (keys which are too small to ever be pressed alone) can produce more than a single result (piece of text, etc) depending on which silver or spot keys the center key is hit with.

2) Any keyboard, of whatever configuration, which contains keys like those described in claim 1.
